(19) United States
(12) Patent Application Publication
(10) Pub. No.: US 2026/0242017 A1
(43) Pub. Date: Aug. 20, 2026

(54) SUSPENDED UNDERCARRIAGE ASSEMBLY, FRAME ASSEMBLY HAVING SAME, AND TRACK SYSTEM

(71) Applicant: SOUCY INTERNATIONAL INC., Drummondville (CA)

(72) Inventors: Yves SAUVAGEAU, Drummondville (CA); Branislav NANAC, Drummondville (CA); David BARRY, Longueuil (CA); Styve ALLIE, Drummondville (CA); Charles ST-ARNAUD, TSt-Maurice (CA); Michel PELLERIN, Drummondville (CA); Steeve PARE, St-Majorique (CA); Marc-Andre PATRY, Drummondville (CA); Gabriel CHANTAL, Saint-Jude (CA); Maxime RIVARD, Saint-Colomban (CA); Thomas ST-PIERRE, Gatineau (CA); William BRISSON, Saint-Cyrille-De-Wendover (CA); Martine LAVOIE, St-Jerome (CA); Patrice de MARTIN, Saint-Colomban (CA); Charles-Etienne BOUCHARD, Drummondville (CA); Anthony DEZIEL, Trois-Rivieres (CA)

(21) Appl. No.: 19/469,651

(22) PCT Filed: Apr. 15, 2024
(86) PCT No.: PCT/CA2024/050483

§ 371 Date: Sep. 26, 2025

Related U.S. Application Data
(60) Provisional application No. 63/458,980, filed on Apr. 13, 2023.

(51) Int. Cl. B62D 55/15; B62D 55/065; B62D 55/10

(52) U.S. Cl. CPC B62D 55/15; B62D 55/10; B62D 55/065

(57) ABSTRACT

A frame assembly for a track system is disclosed. The frame assembly includes a frame member, and a suspended undercarriage assembly moveably connected to the frame member. The suspended undercarriage assembly includes a beam having a leading portion and a trailing portion, a leading bushing connected to the leading portion of the beam, and a trailing bushing connected to the trailing portion of the beam. The leading and trailing bushings are made of a resilient material, and are configured to promote deformation in at least one direction. In response to the beam moving, the leading and trailing bushings bias the beam toward an initial position.

### CROSS-REFERENCE TO RELATED APPLICATION

The present application claims priority to U.S. Provisional Patent Application No. 63/458,980, filed Apr. 13, 2023 entitled “Suspended Undercarriage Assembly For A Truck System”, which is incorporated by reference herein in its entirety.

### FIELD OF THE TECHNOLOGY

The present technology relates to track systems, and more particularly to frame assemblies and suspended undercarriage assemblies for track systems.

### BACKGROUND

Track systems are commonly used with a variety of vehicles in order to use overcome some deficiencies of wheels.

Conventional track systems do, however, have their own disadvantages. They can struggle to seamlessly conform to some types of terrains such as crowned roads. This can result in part of the endless track of the track systems losing contact with the ground and other parts of the endless track experiencing high pressure, which can affect life of components of the track systems, along with stability and manoeuvrability.

Despite ongoing developments in the field of track systems, there is still room for further improvements for track systems. More particularly, improvements related to characteristics of track system, such as ride quality, traction and durability are desirable. In addition, improving such characteristics in a cost-effective manner has proven to be challenging, and thus continued improvements in this area remain desirable.

### SUMMARY

It is an object of the present technology to ameliorate at least some of the inconveniences present in the prior art.

According to an embodiment of the present technology, there is provided a suspended undercarriage assembly connectable to a frame assembly of a track system. The undercarriage assembly includes a beam having a leading portion and a trailing portion, at least one support wheel assembly connected to the beam, a leading pin connected to the leading portion of the beam, a trailing pin connected to the trailing portion of the beam, and leading and trailing bushing assemblies. The leading bushing assembly has a leading body fixedly connected to the leading pin. The leading body is made of a resilient material. The leading bushing assembly is configured to connect to the frame assembly The trailing bushing assembly has a trailing body fixedly connected to the trailing pin. The trailing body is made of a resilient material. The trailing bushing assembly is configured to connect to the frame assembly. The leading and trailing bodies are configured to promote deformation in at least one direction. With the suspended undercarriage assembly being connected to the frame assembly via the leading and trailing bushing assemblies, the leading and trailing bodies enable the beam to move in the at least one direction relative to the frame assembly, and in response to the beam moving, the leading and trailing bodies bias the beam toward an initial position.

In some embodiments, the leading and trailing pins are integral with the beam.

In some embodiments, the suspended undercarriage assembly includes a leading plate connected to the leading portion of the beam, the leading pin being connected to the leading plate, and a trailing plate connected to the trailing portion of the beam, the trailing pin being connected to the trailing plate.

In some embodiments, the leading bushing assembly is configured to be received in a leading recess of a member of the frame assembly, and the trailing bushing assembly is configured to be received in a trailing recess of a member of the frame assembly.

In some embodiments, the leading bushing assembly includes a leading housing, the leading body being received in the leading housing, and the trailing bushing assembly includes a trailing housing, the trailing body being received in the trailing housing.

In some embodiments, the leading bushing assembly includes a leading sleeve receiving at least part of the leading pin therein, and the trailing bushing assembly includes a trailing sleeve receiving at least part of the trailing pin therein.

In some embodiments, the leading body defines an aperture configured to receive the leading sleeve therein, the leading sleeve being fixedly connected to the leading body, and the trailing body defines an aperture configured to receive the trailing sleeve therein, the trailing sleeve being fixedly connected to the trailing body.

In some embodiments, at least one of the leading and trailing bodies has a concave profile for promoting deformation in the at least one direction.

In some embodiments, the concave profile is at a longitudinal forward end or longitudinal rearward end of the at least one of the leading and trailing bodies.

In some embodiments, the at least one direction is at least one of a vertical direction and a lateral direction.

In some embodiments, the leading pin is connected to the leading body closer to a bottom surface of the leading body than to a top surface of the leading body, and the trailing pin is connected to the trailing body closer to a bottom surface of the trailing body than to a top surface of the trailing body.

In some embodiments, a majority of resilient material of the leading body is disposed vertically higher than the leading pin, and a majority of resilient material of the trailing body is disposed vertically higher than the trailing pin.

In some embodiments, the at least one support wheel assembly includes three longitudinally spaced support wheel assemblies.

In some embodiments, in response to the beam pivoting about a longitudinal axis defined by the leading and trailing pins, at least one of the leading and trailing bodies undergoes a torsional deformation.

According to another aspect of the present technology, there is provided a frame assembly for a track system. The frame assembly includes a main body and the suspended undercarriage assembly according to the above aspect or according to the above aspect and one or more of the above embodiments. The suspended undercarriage assembly is connected to the main body.

According to another aspect of the present technology, there is provided a track system including the frame assembly according to the above aspect, a leading idler wheel assembly connected to the frame assembly, a trailing idler wheel assembly connected to the frame assembly, a sprocket wheel assembly rotationally connected to the frame assembly, and an endless track surrounding the frame assembly, the leading and trailing idler wheel assemblies, and the sprocket wheel assembly.

According to another aspect of the present technology, there is provided a frame assembly for a track system. The frame assembly includes a frame member and a suspended undercarriage assembly moveably connected to the frame member. The suspended undercarriage assembly includes a beam having a leading portion and a trailing portion, a leading bushing connected to the leading portion of the beam, and a trailing bushing connected to the trailing portion of the beam. The leading and trailing bushings are made of a resilient material, and are configured to promote deformation in at least one direction. In response to the beam moving relative to the frame member, the leading and trailing bushings bias the beam toward an initial position.

In some embodiments, the frame member defines a cavity, and the suspended undercarriage assembly is at least partially received in the cavity.

In some embodiments, the frame member has a frame limiter, the beam has a beam limiter operationally connected with the frame limiter, and the frame limiter and the beam limiter are configured to limit movement of beam relative to the frame member.

In some embodiments, one of the frame limiter and the beam limiter is a slot, and an other one of the frame limiter and the beam limiter is a peg received in the slot.

In some embodiments, with the frame assembly being in a rest configuration, the leading bushing and the trailing bushing are operationally engaged to the frame member.

In some embodiments, with the frame assembly being in the rest configuration, the frame member and the beam apply a preloading force to the leading and trailing bushings.

In some embodiments, the suspended undercarriage assembly further includes a leading connecting member interconnecting the leading bushing and the leading portion of the beam, and a trailing connecting member interconnecting the trailing bushing and the trailing portion of the beam.

In some embodiments, at least one of a profile of the leading bushing is at least partially complementary to a profile of the leading connecting member, and a profile of the trailing bushing is at least partially complementary to a profile of the trailing connecting member.

In some embodiments, at least one of the leading and trailing bushings has at least one lip extending outwardly from an edge of the at least one of the leading and trailing bushings.

In some embodiments, a shape of the at least one lip varies.

In some embodiments, the at least one lip has a smaller height at corners of the at least one of the leading and trailing bushings.

In some embodiments, the bushing has concave sections.

In some embodiments, the bushing is molded over the connecting member.

In some embodiments, in response to the beam moving relative to the frame member, the leading and trailing bushings mostly deform in compression.

According to another aspect of the present technology, there is provided a track system including the frame assembly according to the above aspect or according to the above aspect and one or more of the above embodiments, a plurality of wheel assemblies connected to the frame assembly, and an endless track surrounding the frame assembly and the plurality of wheel assemblies.

According to another aspect of the present technology, there is provided a resilient bushing assembly for an undercarriage assembly. The undercarriage assembly is connectable to a frame of a track system. The frame defines at least one recess. The undercarriage assembly includes a beam having a leading portion and a trailing portion, a leading pin projecting from the leading portion and a trailing pin projecting from the trailing portion, and at least one support wheel assembly connectable to the beam. The resilient bushing assembly includes a body made of a resilient material. The body has an external shape and defines an aperture sized and dimensioned for fixedly receiving one of the leading pin and the trailing pin for resiliently connecting the beam of the undercarriage assembly to the frame of the track system. The resilient bushing assembly is at least partially receivable in the at least one recess of the frame for connecting the beam of the undercarriage assembly to the frame. The resilient bushing is shaped and dimensioned for promoting deformation of the bushing in at least one of a vertical direction and a lateral direction. The bushing is resiliently deformable to permit movement of the beam relative to the frame assembly in the vertical direction and in the lateral direction, and to resiliently bias the beam towards a rest position with respect to the frame.

According to another aspect of the present technology, there is provided a suspended undercarriage assembly connectable to a multi-member frame assembly of a track system. The multi-member frame assembly defines at least one recess. The suspended undercarriage assembly includes a beam having a leading portion and a trailing portion, a leading pin projecting from the leading portion and a trailing pin projecting from the trailing portion, at least one support wheel assembly connectable to the beam, and first and second resilient bushings according to the above aspect. The first resilient bushing is connected to the leading portion of the beam, and defines a leading aperture sized and dimensioned for receiving the leading pin for connecting the beam to the first resilient bushing. The second resilient bushing is connected to the trailing portion of the beam, and defines a trailing aperture sized and dimensioned for receiving the trailing pin for connecting the beam to the second resilient bushing.

The first and second resilient bushings are at least partially receivable in the at least one recess for connecting the beam to the multi-member frame assembly. The at least one of the first and second resilient bushings includes a bushing being shaped and dimensioned for promoting deformation of the bushing in at least one of a vertical direction and a lateral direction. The bushing is resiliently deformable to permit movement of the beam relative to the multi-member frame assembly in the vertical direction and in the lateral direction, and to resiliently bias the beam towards a rest position with respect to the multi member frame assembly.

According to another aspect of the present technology, there is provided a track system for a vehicle. The track system includes a multi-member frame assembly connectable to a chassis of the vehicle, the multi-member frame assembly defining at least one recess, a leading idler wheel assembly at least indirectly connected to the multi-member frame assembly, a trailing idler wheel assembly at least indirectly connected to the multi-member frame assembly, and the suspended undercarriage assembly according to the above aspect.

The principles of the present technology are generally embodied in a track system configured to be installed on a vehicle in replacement of one of the wheels of the vehicle, or as standard equipment on the vehicle. The track system of the present technology includes a multi-member frame assembly, leading and trailing idler wheel assemblies, a suspended undercarriage assembly having support wheels assemblies disposed intermediate the leading and trailing idler wheel assemblies, and an endless track.

The suspended undercarriage assembly has resilient bushing assemblies allowing movement of the support wheel assemblies of the track system relative to the multi-member frame assembly of the track system. The track system thus has the capability of absorbing or mitigating at least a portion of the shocks and vibrations induced in the track system when the vehicle equipped with such track system travels over an uneven terrain. Moreover, the suspended undercarriage assembly of the track system allows the endless track of the track system to better conform to the terrain on which the track system travels, at least over a portion of the ground-engaging segment of the endless track.

In accordance with the principles of the present technology, the resilient bushing assemblies allow translational movements and/or pivotal movements of the support wheel assemblies relative to the multi-member frame assembly of the track system.

In the context of the present specification, unless expressly provided otherwise, the words “first”, “second”, “third”, etc. as well as “primary” and “secondary” have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, right side of a vehicle having track systems in accordance to embodiments of the present technology;

FIG. 2 is a perspective view taken from a top, rear, right side of a rear right track system of the vehicle of FIG. 1;

FIG. 3 is a perspective view taken from a top, rear, right side of the track system of FIG. 2, with an endless track being omitted;

FIG. 4 is a right side elevation view of the track system of FIG. 3;

FIG. 5 is a perspective view taken from a bottom, front, right side of the track system of FIG. 3;

FIG. 6 is a bottom plan view of the track system of FIG. 3;

FIG. 7 is a rear elevation view of the track system of FIG. 3;

FIG. 8 is a perspective view taken from a top, rear, right side of the track system of FIG. 3, with part of the drive wheel assembly being omitted;

FIG. 9 is a perspective view taken from a top, front, left side of the track system of FIG. 4, with laterally outer wheels being omitted;

FIG. 10A is a cross-sectional view taken along a longitudinal plane;

FIG. 10B is a side elevation view of part of the track system according to an alternative embodiment of the present technology;

FIG. 11 is a perspective view taken from a bottom, front, left side of the track system of FIG. 3, with a suspended undercarriage assembly being omitted.

FIG. 12A is a perspective view taken from a top, front, left side of an suspended undercarriage assembly of the track system of FIG. 3;

FIG. 12B is a perspective view taken from a top, front, left side of the suspended undercarriage assembly of FIG. 12A, with some of the wheels being omitted;

FIG. 12C is a close-up of a front portion the suspended undercarriage assembly of FIG. 12A, with a leading bushing assembly being omitted;

FIG. 13A is a close-up of a portion of a suspended undercarriage assembly according to an alternative embodiment of the present technology;

FIG. 13B is a close-up of a portion of a suspended undercarriage assembly according to an alternative embodiment of the present technology;

FIG. 14A is a perspective view of a bushing and a sleeve, the bushing being in a first state;

FIG. 14B is a front elevation view of the bushing and the sleeve of FIG. 14A;

FIG. 14C is a cross-sectional view of the bushing and the sleeve of FIG. 14A, taken along the line 14C-14C of FIG. 14B;

FIG. 14D is a perspective view of the bushing and the sleeve of FIG. 14A, the bushing 14A being in a compressed state;

FIG. 14E is a left side elevation view of the bushing and the sleeve of FIG. 14D;

FIG. 14F is a cross-sectional view of the bushing and the sleeve of FIG. 14D;

FIG. 15A is a perspective view taken of part of a bushing and part of a sleeve of an alternative embodiment of the present technology;

FIG. 15B is a right side elevation view of the part of the bushing and the part of the sleeve of FIG. 15A;

FIG. 16A is a cross-sectional perspective view taken from a rear, bottom, right side of the track system of FIG. 3; the cross-section being taken along a lateral plane through a trailing bushing, with the track system being in rest configuration;

FIG. 16B is a cross-sectional perspective view of the track system of FIG. 16A, with the suspended undercarriage assembly being in a first position;

FIG. 16C is a cross-sectional perspective view of the track system of FIG. 16A, with the suspended undercarriage assembly being in a second position;

FIG. 17 is a schematic rear elevation view of the vehicle of FIG. 1 travelling on a crowned road;

FIG. 18A is a perspective view of a bushing assembly according to an alternative embodiment of the present technology;

FIG. 18B is a front elevation view of the bushing assembly of FIG. 18A;

FIG. 18C is a cross-sectional view taken along line 18C-18C of the bushing assembly of FIG. 18A;

FIG. 18D is a perspective view of the bushing assembly of FIG. 18A in a deformed state;

FIG. 18E is a side elevation view of the bushing assembly of FIG. 18D;

FIG. 18F is a front elevation view of the bushing assembly of FIG. 18D;

FIG. 19A is a perspective view of a bushing and frame assembly portions;

FIG. 19B is a front elevation view of the bushing and the frame assembly portions of FIG. 19A;

FIG. 19C is a cross-sectional view taken along the line 19C-19C of the bushing and the frame assembly portions of FIG. 19A;

FIG. 19D is a perspective view of the bushing and the frame assembly portions of FIG. 19A, with the bushing being in a deformed state;

FIG. 19E is a side elevation view of the bushing and the frame assembly portions of FIG. 19D;

FIG. 19F is a front elevation view of the bushing and the frame assembly portions of FIG. 19D;

FIG. 20A is a cross-sectional view of part of a frame assembly according to an embodiment of the present technology, the cross-section taken through a longitudinal plane;

FIG. 20B is a perspective view of a suspended undercarriage assembly of the frame assembly of FIG. 20A;

FIG. 20C is a cross-sectional view of the suspended undercarriage assembly of FIG. 30B;

FIGS. 21A and 21B are perspective views of a bushing and a connecting portion according to an embodiment of the present technology;

FIG. 21C is a cross-sectional view of the bushing and the connecting portion of FIG. 21A taken along a lateral plane;

FIG. 22 is a perspective view of a bushing and a connecting portion according to an alternative embodiment of the present technology;

FIG. 23 is a perspective view of a bushing and a connecting portion according to an alternative embodiment of the present technology;

FIG. 24 is a perspective view of a bushing and a connecting portion according to an alternative embodiment of the present technology;

FIG. 25A is a perspective view of a bushing and a connecting portion according to an alternative embodiment of the present technology;

FIG. 25B is a cross-sectional view of the bushing and the connecting portion of FIG. 25A taken along a lateral plane; and

FIG. 26 is a perspective view of a bushing and a connecting portion according to an alternative embodiment of the present technology.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

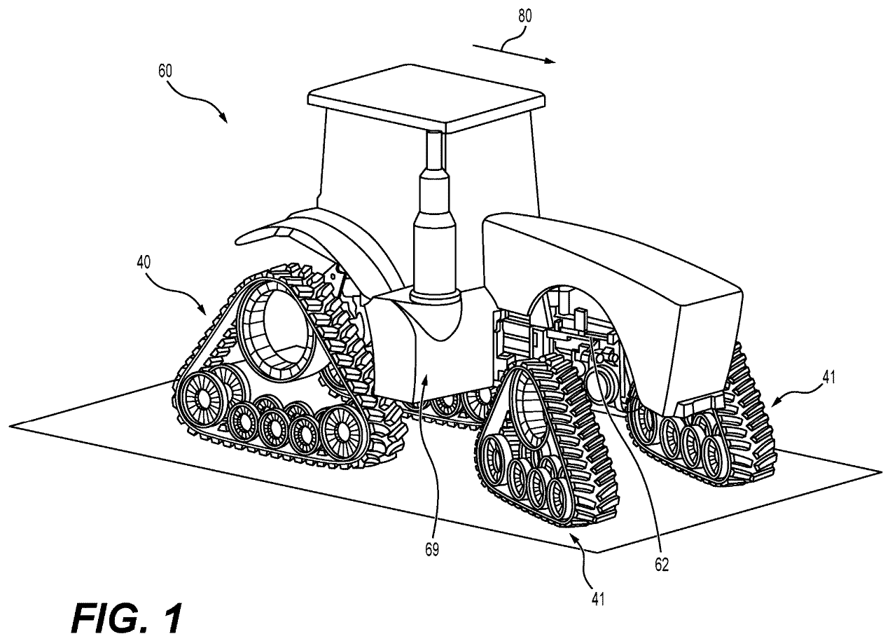

Referring to FIG. 1, the present technology will be described with reference to track systems 40 connected to a vehicle 60. The vehicle 60 is a tractor. It is contemplated that in other embodiments, the vehicle 60 could be another type of vehicle such as an agricultural vehicle, an industrial vehicle, a military vehicle, an exploratory vehicle or a recreational vehicle.

The vehicle 60 has a chassis 62 and a frame 63. The frame 63, which is supported by the chassis 62 defines an operator cabin. The vehicle 60 further has two rear track systems 40, and two front track systems 41.

The vehicle 60 also has two pivot pins 64 (one of which is shown in FIG. 7) disposed at the rear of the vehicle, and two driving shafts 68 (one of which is shown in FIG. 7) also disposed at the rear of the vehicle. As will be described below, each one of the rear track systems 40 is operatively connected to one of the pivot pins 64 and one of the driving shafts 68.

Each one of the pivot pins 64 extend laterally from the chassis 62 and defines a pivot axis 65. In some embodiments, the pivot pins 64 may be integral with the chassis 62. In other embodiments, the pivot pins 64 and the chassis 62 may be separate parts connected to one another. The pivot pins 64 can assist in transmitting load from the vehicle 60 to the track systems 40. The driving shafts 68 also extend laterally from the chassis 62 and are operatively connected to a motor 69 (shown in FIG. 1) that is supported by the chassis 62.

It is contemplated that the connection between the track systems 40 and the vehicle 60 may vary. For example, in some embodiments, the pivot pins 62 could be omitted, and the track systems 40 could be connected to the vehicle solely via the driving shafts 68. The front track systems 41 are connected to the vehicle 60 by a steering assembly (not shown).

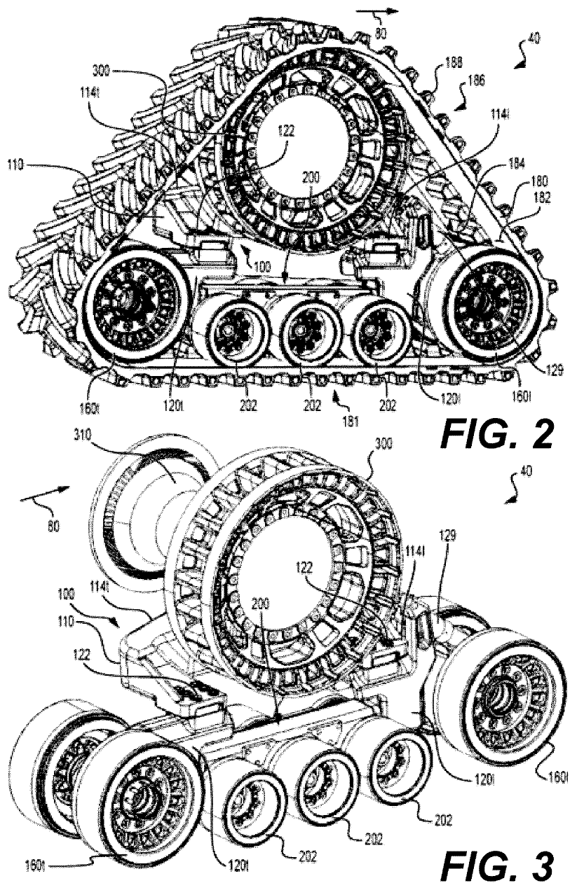

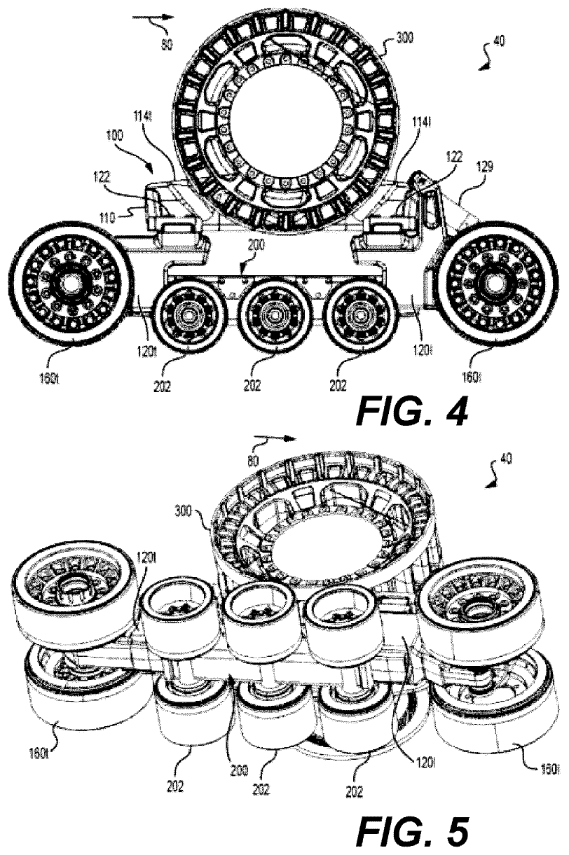

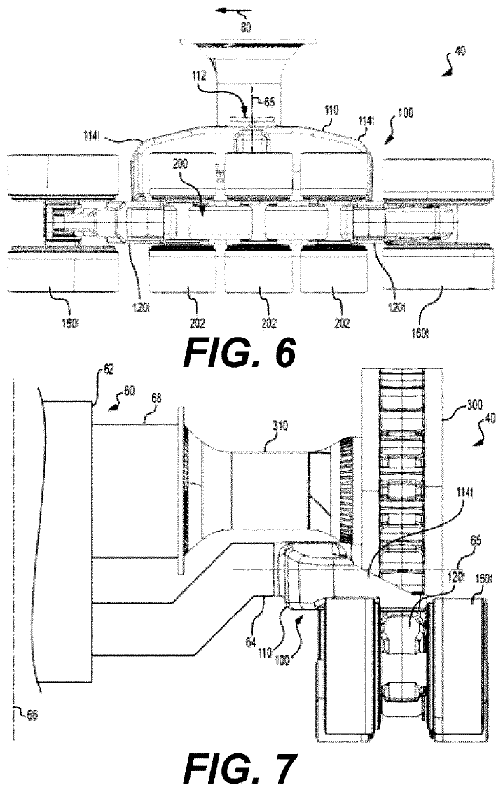

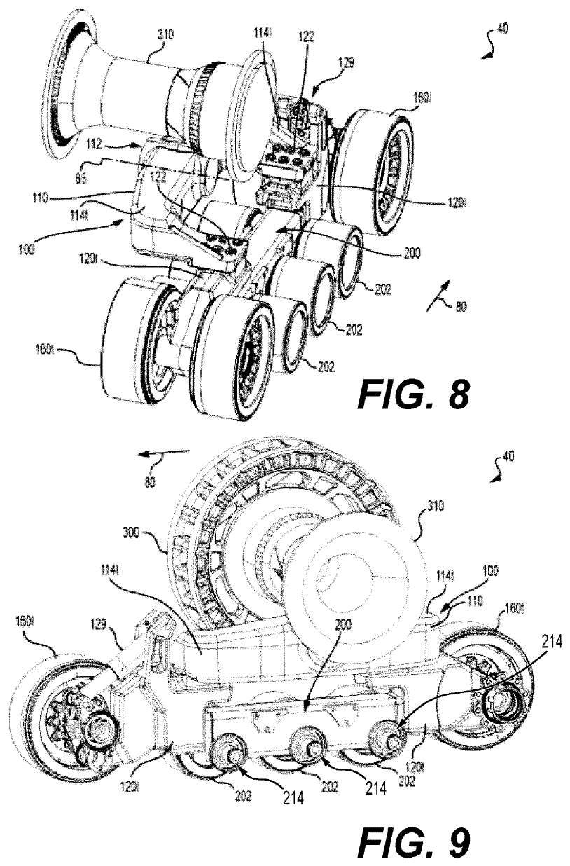

Referring to FIGS. 2 to 9, the track systems 40 will now be described in. greater detail. As the track systems 40 are generally similar, only one rear track system 40, which is connected to the rear right side of the vehicle 60, will be described herewith.

The direction of forward travel of the track system 40 is indicated by an arrow 80. Henceforth, the “leading” components of the track system 40 are identified with an “l” added to their reference numeral, and the “trailing” components are identified with a “t” added to their reference numeral (i.e. components of the track system 40 are defined consistently with the vehicle's forward direction of travel).

Furthermore, it is to be understood that in the present description, a wheel assembly includes one or more wheels, an axle for supporting the one or more wheels, and the components (bearings, seals, etc.) that are necessary for the wheel(s) to rotate. Different wheel assemblies may thus not be described in great detail. Moreover, the expression “at least indirectly connected” is understood to mean that a component may be connected to another component via one or more intermediate structures or members, and that these intermediate structures are not necessarily described in the current description. Thus, for a first component connected to a second component via a third component, it can be said that the first and second components are connected to one another, are indirectly connected to one another or are connected to one another via the third component.

The track system 40 includes a frame assembly 100, leading and trailing idler wheel assemblies 160l, 160t, support wheel assemblies 202, a drive wheel assembly 300 and an endless track 180.

The frame assembly 100, which can be referred to as a multi-member frame assembly 100, includes a primary frame member 110, leading and trailing secondary frame members 120l, 120t and a suspended undercarriage assembly 200. In some embodiments, the suspended undercarriage assembly 200 may be considered to be distinct from the frame assembly 100. The leading and trailing secondary frame members 120l, 120t are connected to the primary frame member 110, and the suspended undercarriage assembly 200 is connected to the leading and trailing secondary frame members 120l, 120t. It is contemplated that in other embodiments, the frame assembly 100 may include a single frame member and the suspended undercarriage assembly 200 may be connected thereto. The frame assembly 100 will be described in greater detail below.

The leading and trailing idler wheel assemblies 160l, 160t, which may be referred to as guide wheel assemblies, are rotationally connected to the frame assembly 100. More specifically, the leading idler wheel assembly 160l is connected to the leading frame member 120l via a tensioner assembly 129. The tensioner assembly 129 is selectively operable to move the leading idler wheel assembly 160l away or toward the frame assembly 100 for adjusting a tension in the endless track 180. The trailing idler wheel assembly 160t is connected to the trailing frame member 120t.

The support wheel assemblies 202, which can be referred to as road wheel assemblies or roller wheel assemblies, are rotationally connected to the frame assembly 100. More specifically, the support wheel assemblies 202 are connected to the suspended undercarriage assembly 200, and are disposed longitudinally between the leading and trailing idler wheel assemblies 160l, 160t. In the present embodiment, there are three longitudinally spaced support wheel assemblies 202. It is contemplated that in other embodiments, there may be more or fewer than three support wheel assemblies 202.

The leading and trailing idler wheel assemblies 160l, 160t and the support wheel assemblies 202 distribute the load born by the track system 40 over a ground-engaging segment 181 (FIG. 2) of the endless track 180.

The drive wheel assembly 300 is drivingly connected to the driving shaft 68 via a drive axle 310 and drivingly connected to the endless track 180 via lugs 184. Thus, in operation, the motor 69 drives the driving shaft 68, which in turn drives the drive axle 310, which in turn drives the drive wheel assembly 300, which drives the endless track 180, thereby driving the track system 40.

The endless track 180 extends around the frame assembly 100, around the leading and trailing idler wheel assemblies 160l, 160t and the support wheel assemblies 202. The endless track 180 has an inner surface 182 engaging the leading and trailing idler wheel assemblies 120l, 120t, the support wheel assemblies 202 and the drive wheel assembly 300. The lugs 184 are disposed on a central portion of the inner surface 182. The leading and trailing idler and support wheel assemblies 120l, 120t, 202 have laterally spaced wheels engaging the inner surface 182 of the endless track 180 on either side of the lugs 184. The endless track 180 also has an outer surface 186 with a tread 188 selected for ground engagement. The tread 188 may vary in different embodiments according to the type of vehicle on which the track system 40 is to be used with and/or the type of ground surface on which the vehicle is destined to travel.

The endless track 180 is an endless polymeric track It is contemplated, however that the endless track 180 may be constructed of a wide variety of materials and structures including metallic components. The specific properties and materials of the endless track 180 are not central to the present technology and will not be described in detail.

In some embodiments, the track system 40 is configured to be operatively connected to a steering assembly of the vehicle 60, and thus be steerable. In some embodiments, a gearbox is operatively connected between the track system 40 and the driving shaft 68 of the vehicle 60. In some embodiments, the track system 40 is configured to be installed on a non-driving vehicle axle shaft.

Still referring to FIGS. 2 to 9, the frame assembly 100 will now be described in greater detail.

The primary frame member 110 is one integral member with a leading portion 114l and a trailing portion 114t. In some embodiments, the primary frame member 110 may be made of multiple portions connected to one another. For example, the leading portion 114l and the trailing portion 114t may be separate components that are connected together. The leading and trailing portions 114l, 114t extend generally laterally away from the vehicle 60, and partially vertically downward. Thus, the primary frame 110 generally forms, when seen from above, a U-shape and/or a C-shape. It is understood that the shape of the primary frame 110 may differ without departing from the scope of the present technology. Longitudinally between the leading and trailing portions 114l, 114t, the primary frame member 110 defines an aperture 112 that is configured to receive the pivot pin 64 therein.

The connection of the pivot pin 64 and the aperture 112 enables the primary frame member 110 to pivot relative to the chassis 62 about the pivot axis 65. Thus, the primary frame member 110 can be said to be pivotally connected to the chassis 62. Thus, when the track system 40 is travelling on a terrain such as a hill or travelling over an obstacle, the primary frame member 110 can pitch positively or negatively about the pivot axis 65 to conform to the contour of the terrain or to overcome the obstacle.

Additionally, part of the weight of the vehicle 60 borne by the track system 40 is transmitted from the chassis 62 to the primary frame member 110, from the primary frame member 110 to the leading and trailing secondary frame members 120l, 120t, and in turn to the wheel assemblies 160l, 160t, 202. Thus, it will be noted that the drive wheel assembly 300 does not sustain a material portion of the load borne by the track system 40.

It is contemplated that in some embodiments, the pivot pin 64 may be part of the primary frame member 110, and a pin recess may be defined in the chassis 62. In other embodiments, the pivot pin 64 may part of an adapter assembly installed between the vehicle 60 and the track system 40. An example of such a configuration is described in Patent Application No. PCT/IB2017/050721, entitled “Steering Knuckle, Steerable Track System, and Vehicle”, and in Patent Application No. PCT/IB2017/054986, entitled “Steering Knuckle Gearbox Assembly”, both of which are incorporated by reference in their entirety. The adapter plate includes a pin is installed between the vehicle and the track system in order to allow a pivotable installation of a track kit assembly on a vehicle.

The leading and trailing secondary frame members 120l, 120t will now be described in greater detail. The leading secondary frame member 120l is connected to the leading portion 114l of the primary frame member 110 via fasteners 122. The trailing secondary frame member 120t is connected to the trailing portion 114t of the primary frame member 110, also via fasteners 122. In some embodiments, it is contemplated that the leading and trailing secondary frame members 120l, 120t could be a unitary member instead of two separate members.

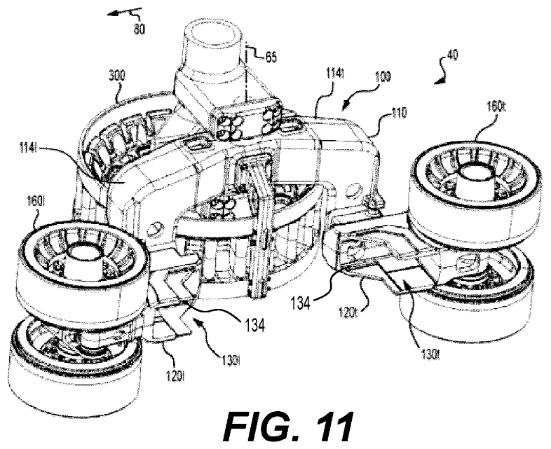

The leading secondary frame member 120l defines a leading recess 130l, and the trailing secondary frame member 120t defines a trailing recess 130t. As best seen in FIG. 11, the leading recess 130l is accessible longitudinally from a rear of the leading secondary frame member 120l and vertically from a bottom of the leading secondary frame member 120l, whereas the trailing recess 130t is accessible longitudinally from a front of the trailing secondary frame member 120t, and vertically from a bottom of the trailing secondary frame member 120t. Thus, due to the leading and trailing recesses 130l, 130t, the leading and trailing secondary frame members 120l, 130t can be said to have one open-ended side.

Each one of the recesses 130l, 130t has a profile that is generally rectangular (i.e., a cross-section taken along a lateral plane, where the lateral plane extends through the leading or trailing secondary frame members 120l, 120t, defines a generally rectangular cross-section). It is contemplated that the leading and trailing recesses 130l, 130t may be shaped differently (e.g., trapezoidal shape). Shoulders 134 extend laterally into the leading and trailing recesses 130l, 130t from, respectively, the leading and trailing secondary frame members 120l, 120t.

As will be described below, the leading and trailing recesses 130l, 130t are configured (shaped and sized) to receive portions of the suspended undercarriage assembly 200, for connecting the suspended undercarriage assembly 200 to the secondary leading and trailing frame members.

The primary frame member 110 and the leading and trailing secondary frame members 120l, 120t are typically made of rigid material, such as aluminum, steel or any other suitable material. In the present embodiment, the leading and trailing secondary frame members 120l, 120t are hollow, but could be solid in other embodiments. Hollow leading and trailing secondary frame members 120l, 120t may assist in reducing the overall weight of the frame assembly 100 while substantially maintaining the structural properties thereof. It is contemplated that within the scope of the present technology, the primary frame member 110 and the leading and trailing members 120l, 120t may be constructed of a wide variety of materials and structures and may differ in shapes and configurations.

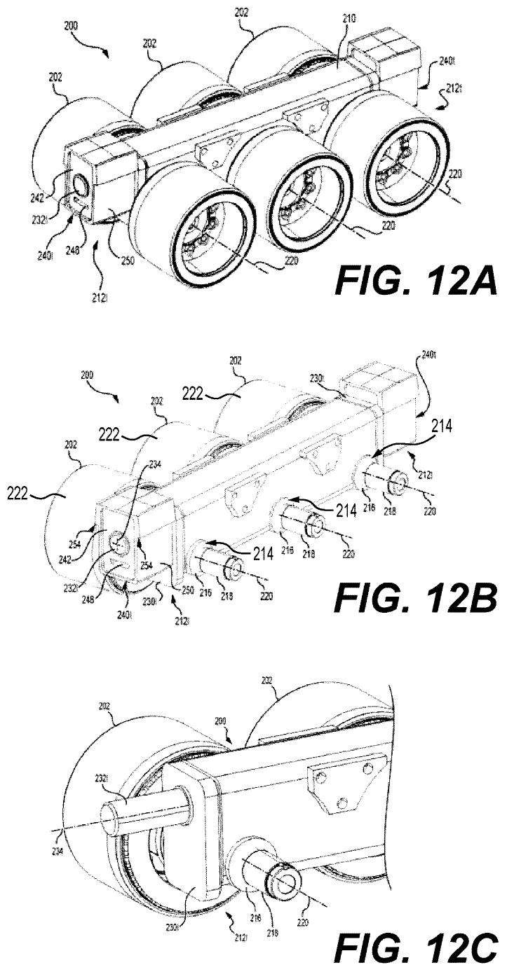

Referring to FIGS. 12A to 12C, the suspended undercarriage assembly 200 will now be described in greater detail. The suspended undercarriage assembly 200 includes a beam 210, leading and trailing plates 230l, 230t and leading and trailing bushing assemblies 240l, 240t.

The beam 210 is generally prismatic, and has a rectangular profile (i.e., a cross-section taken along a lateral plane, where the lateral plane extends through the beam 210 provides a generally rectangular cross-section). The use of standard shapes (e.g., prismatic with a rectangular profile) can assist in reducing the overall costs of the track system 40. It is contemplated that the shape and profile of the beam 210 may vary.

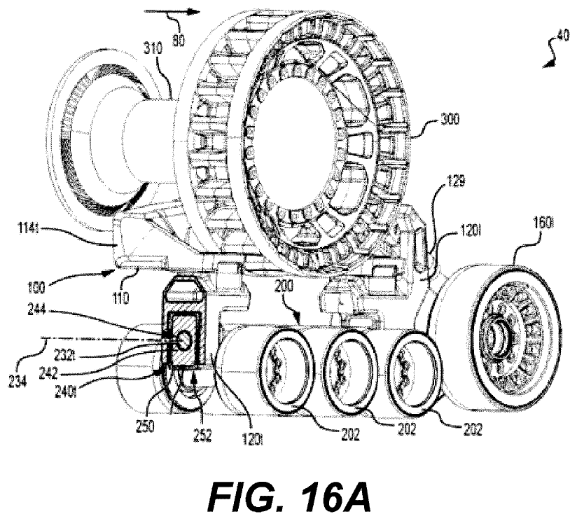

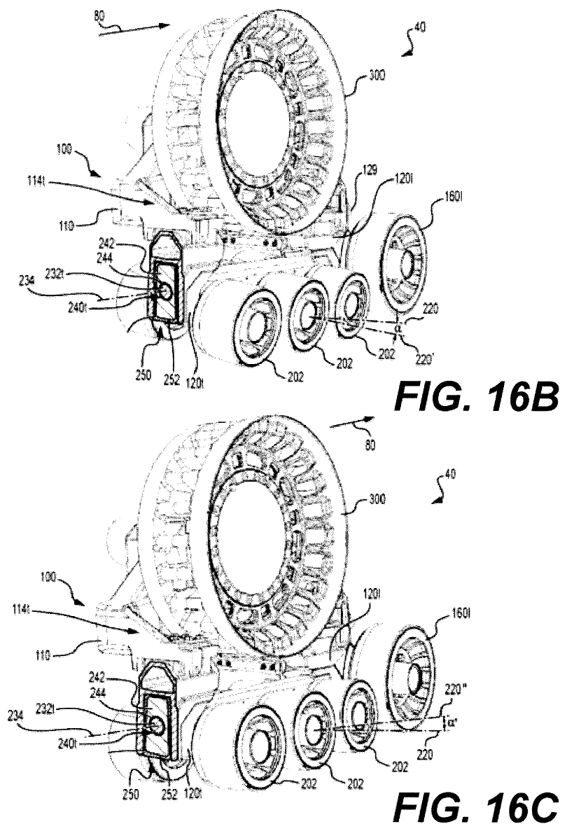

The beam 210 has a leading portion 212l and a trailing portion 212t. Longitudinally between the leading and trailing portions 212l, 212t, the beam 210 defines three laterally extending apertures 214 that are longitudinally spaced from one another. The apertures 214 are positioned such that when the frame assembly 100 is fully assembled and in a rest configuration (shown in FIGS. 2 and 16A, and described in greater detail below) (i.e., suspended undercarriage assembly 200 connected to the primary and secondary frame members 210, 220l, 220t), the apertures 214 are longitudinally offset from the pivot axis 65. Each one of the apertures 214 is configured to receive one of the support wheel assemblies 202 therein. More specifically, each support wheel assembly 202 includes an axle casing 216 and an axle 218, with the axle casing 216 being received in the corresponding aperture 214, and the axle 218 being rotationally connected to the axle casing 216. Each axle 218 supports two laterally spaced support wheels 222. Each axle 218 defines a wheel axis 220 about which the support wheels 222 rotate. In some embodiments, a pair of support wheel assemblies 202 may be configured in a tandem assembly and/or may be pivotally connected to the beam 210.

The longitudinal offset between the pivot axis 65 and the support wheel assemblies 202 may, when the vehicle 60 is travelling on uneven terrain under certain conditions, assist in reducing the vertical displacement undergone by the chassis 62 of the vehicle 60, and/or may reduce the tendency of any one of the support wheel assembly 202 of oscillating laterally.

The beam 210, like the secondary leading and trailing frame members 120l, 120t is made of a generally rigid material such as aluminum or steel, and is hollow. It is contemplated that within the scope of the present technology, the beam 210 may be constructed of a wide variety of materials and structures and may differ in shapes and configurations.

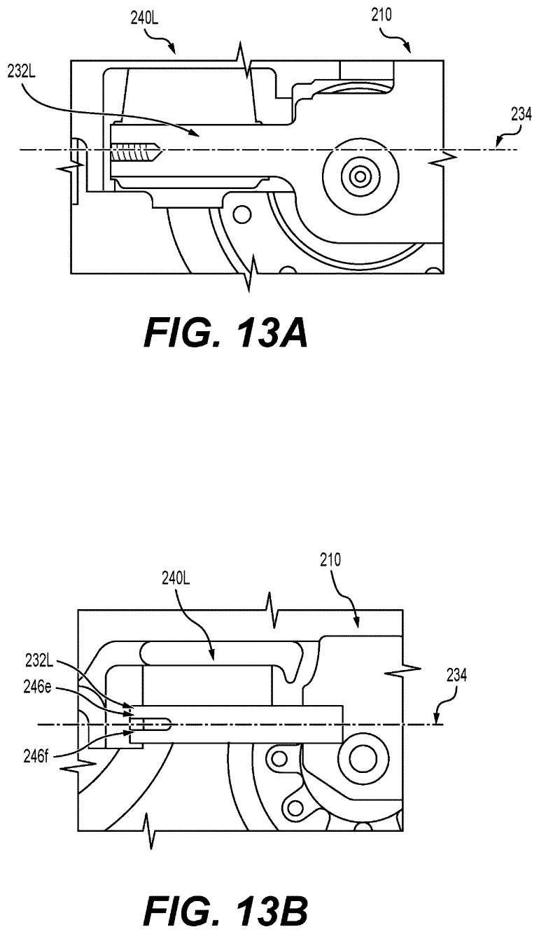

Referring to FIG. 13A, the leading plate 230l is connected to the leading portion 212l of the beam 210, and has a leading pin 232l extending therefrom. The trailing plate 230t is connected to the trailing portion 212t of the beam 210, and has a trailing pin 232t extending therefrom. In some embodiments, the leading and trailing plates 230l, 230t may be integral with the beam 210. The leading and trailing pins 232l, 232t are cylindrical, but could be shaped otherwise in other embodiments. For example, the leading and/or trailing pins may define a flat section or a keyway.

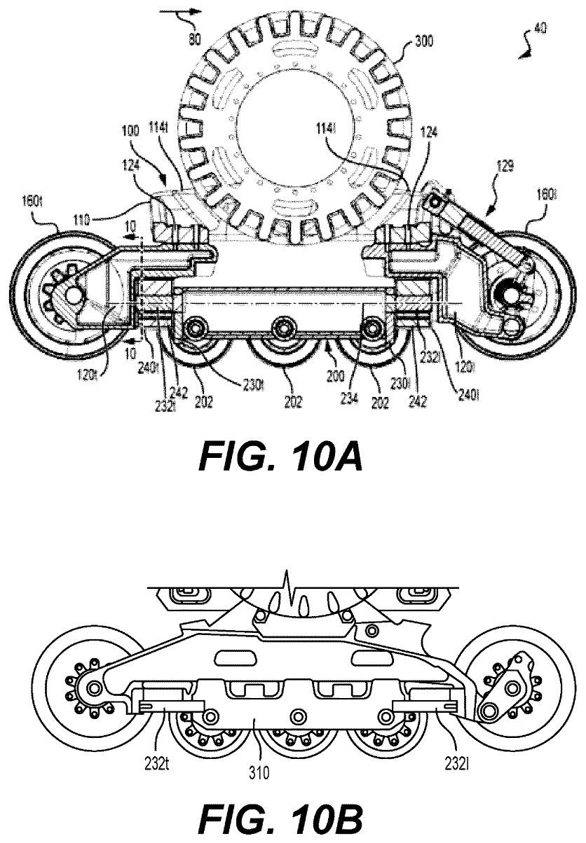

In the present embodiment, the leading pin 232l is integral with the leading plate 230l and the trailing pin 232t is integral with the trailing plate 230t. In another embodiment, such as the embodiment shown in FIG. 13A, the leading pin 232l is integral with the beam 210 (it is contemplated that similarly, the trailing pin 232t may also be integral with the beam 210). In yet another embodiment, such as the embodiment shown in FIGS. 10B and 13B, the leading and trailing pins 232l, 232t are mechanically assembled to the beam 210. Examples of fastening include press-fitting, screwing, fastening, gluing, welding, etc.

The pins 232l, 232t collectively define an undercarriage pivot axis 234 extending longitudinally. As will be described below, the suspended undercarriage assembly 200 may pivot about the undercarriage pivot axis 234, and the undercarriage pivot axis 234 can move.

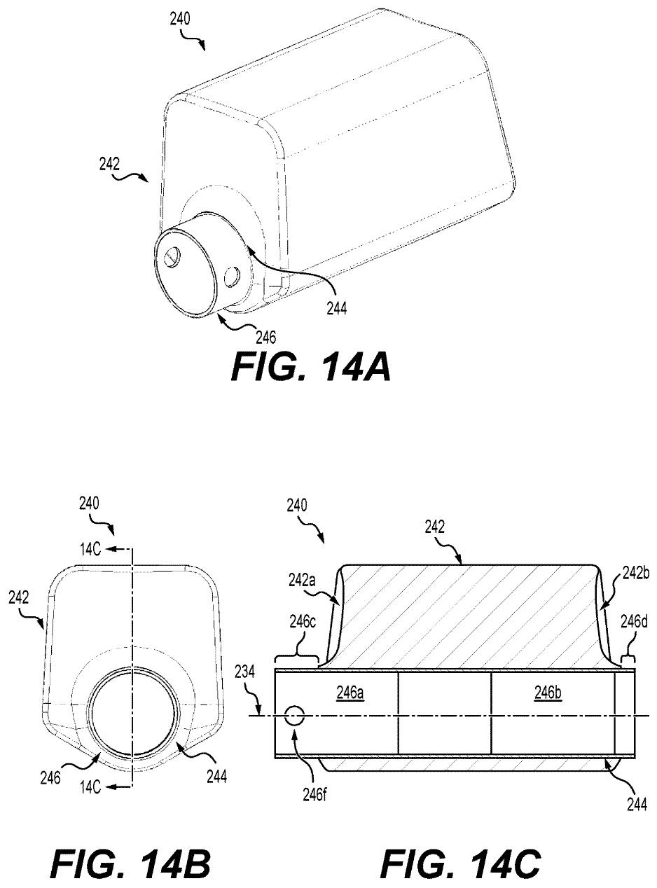

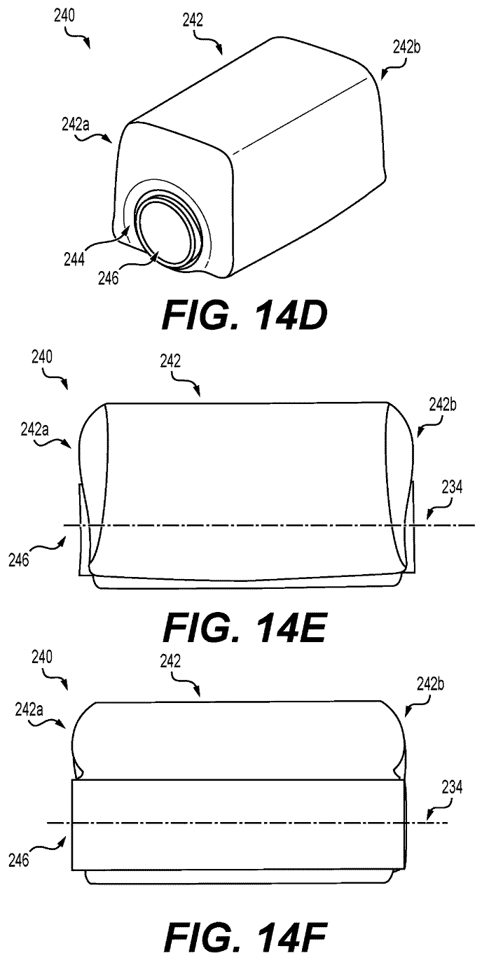

Referring to FIGS. 12A to 12C and 14A to 14C, the leading and trailing bushings 240l, 240t will now be described. The leading bushing assembly 240l is connected to the leading portion 212l of the beam 210 via the leading pin 232l, and the trailing bushing assembly 240t is connected to the trailing portion 212t of the beam 210 via the trailing pin 232t. As the leading and trailing bushing assemblies 240l, 240t are similarly structured, only the leading bushing assembly 240l will be described in detail herewith.

The leading bushing assembly 240l includes a leading body 242 (which may be simply referred to as a body 242 or a bushing 242), a leading sleeve 246 (which may be simply referred to as sleeve 246) and a leading housing 250 (which may be simply referred to as housing 250).

The bushing 242 is made of a resilient material. In some embodiments, the resilient material is one of an elastomer, a rubber or a silicon-based material. Thus, in response to the bushing 242 being deformed, the bushing 242 is biased to return toward its non-deformed position. The bushing 242 defines an aperture 244. The aperture 244 extends generally longitudinally, and is configured (sized and shaped) to receive the sleeve 246 and/or the leading pin 232l therein. It will be noted that the aperture 244 is closer to a bottom of the body 242 than to a top of the body 242, such that a majority of the resilient material is disposed vertically above the aperture 244.

The bushing 242 is configured (sized and shaped) to allow a greater deformation thereof in the vertical direction than in the lateral direction. In other embodiments, the bushing 242 may be configured to allow a greater deformation in the lateral direction than in the vertical direction. In the present embodiment, the increase in material above the aperture 244 enables the body 242 to deform more in the vertical direction. Additionally, the bushing 242 has, at a front end thereof a concave surface 242a, and at rear end thereof, a concave surface 242b. As the bushing 242 is subjected to increasing loads, the bushing 242 deforms such that the concave surfaces 242a, 242b deform outwardly to become convex surfaces (as shown in FIGS. 14D to 14F).

As will be described below, when the leading pin 232l is connected to the bushing 242, the beam 210 is connected to the leading bushing assembly 240l, and pivotal and translational movements of the leading pin 232l (as the support wheel assemblies 202 engage the ground-engaging segment 181 of the endless track 180) are communicated to the bushing 242.

The sleeve 246, which is generally tubular, is received in the aperture 244, and is configured to receive the leading pin 232l therein. Thus, the sleeve 246 is disposed radially between the bushing 242 and the leading pin 232l.

The sleeve 246 is fixedly connected to the bushing 242, such that the sleeve 246 is generally prevented from rotating or sliding with respect to the bushing 242. In some instances, this may be achievable by an overmolding process or a gluing process.

The sleeve 246 is sized, in the longitudinal direction, to extend longitudinally beyond either longitudinal side of the leading body 242. More specifically, on one longitudinal side, the sleeve 246 has a first portion 246 that extends longitudinally beyond the bushing 242 by a distance 242c, and on the other longitudinal side, the sleeve 246 has a second portion 246 that extends longitudinally beyond the bushing 242 by a distance 242d. As best seen in FIG. 14C, the distance 242c is greater than the distance 242d. In some embodiments, the distance 242c may be the same, or smaller than the distance 242d. The first and second portions 246a, 246b of the sleeve 246 can be integral with each other or longitudinally separated from each other by a gap.

As mentioned above, the sleeve 246 is configured to connect to the leading pin 232l. In some embodiments, the connection between the leading pin 232l and the sleeve 246 is a press-fit connection. In other embodiments, the connection between the leading pin 232l and the sleeve 246 is a slide-fit connection, where rotation and translation of the leading pin 2431 relative to the sleeve 246 are blocked after assembly of the leading pin 232l with the sleeve 246. For example, referring to the embodiment shown in FIG. 13B, relative rotation and translation may be blocked by inserting a dowel pin 246e through a common hole 246f defined in the sleeve 246 and the leading pin 232l.

It is contemplated that in some embodiments, the sleeve 246 may be omitted.

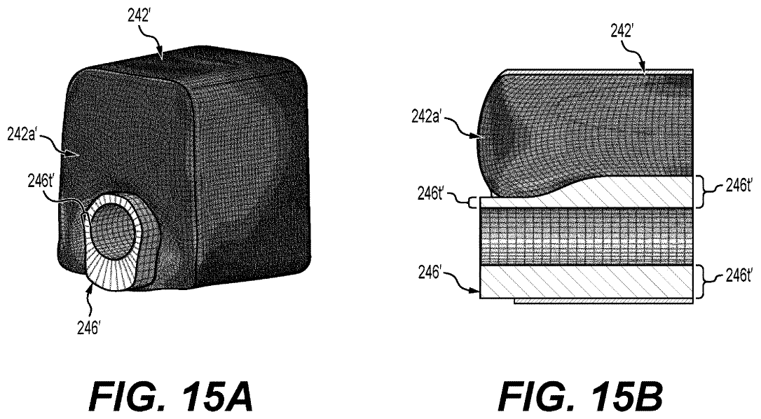

Referring to FIGS. 15A and 15B, part of a bushing 242′ and part of a sleeve 246′ according to an alternative embodiment of the present technology are shown. In this embodiment, the sleeve 246′ has a non-cylindrical cross-sectional shape. More specifically, in this embodiment, the sleeve 246′ provides an embossed portion extending radially along at least a longitudinal portion of the sleeve 246′. In other words, a radial thickness 246t′ of the sleeve 246′ can vary around the sleeve 246′, in a radial direction and/or in a longitudinal direction.

As mentioned above, at least a portion of the leading and/or trailing pins 232l, 232t can have a non-circular cross-section (e.g., could define a flat section). In such. cases, the sleeve 246 would have a complementary shape. It is understood that the aperture 244 of the bushing 242 is complementary to the non-cylindrical cross-sectional shape of the leading/trailing pins 232l/232t (and/or sleeve 246 if applicable).

Referring back to FIGS. 12A to 12C, the housing 250 will now be described in greater detail. The housing 250 is configured to receive the bushing 242 therein, and is configured to connect to the secondary leading member 120l.

More specifically, the housing 250 defines a recess configured to receive the bushing 242 In the present configuration, the bushing 242 and the housing 250 are connected by a press-fit connection. It is contemplated that the bushing 242 and the housing 250 may be connected via fasteners, glue, adhesive, overmolding, or another suitable bonding technique. The housing 250 is configured to maintain the bushing 242 in a pre-stressed condition (under compression). This can assist in increasing durability thereof, as crack propagation is mitigated when the material forming the bushing 242 is under compression.

Additionally, the housing 250, which may be made of a metallic material such as steel, has a generally rectangular profile that is complementary to the profile of the leading recess 130l (FIG. 11). In other embodiments, a profile of the housing 250 may vary depending on the profile of the leading recess 130l. The housing 250 has shoulders 254 that extend generally laterally outward from the lateral sides thereof. The shoulders 254 are configured to engage with the shoulders 134 of the secondary leading member 120l.

The housing 250 can be slidably insertable in the leading recess 130l from longitudinal rearward and vertically lower ends of the leading secondary frame member 120l. When the housing 250 is slidably engaged in the leading recess 130l, the housing 250 is retained in the leading recess 130l and can only slide longitudinally. It is to be noted that the engagement of the shoulders 134, 254 prevents the housing 250 from falling out of the leading recess 130l. It is contemplated that the housing 250 could be further connected to the leading secondary frame member 120l using fasteners, or another suitable bonding technique.

In some embodiments, the housing 250 may be omitted, such that the bushing 242 may be directly received in the leading recess 130l .

Referring back to the frame assembly 100, when the housing 250 of the leading bushing assembly 240l is connected to the leading secondary frame member 120l, and the trailing bushing assembly 240t is connected to the trailing secondary frame member 120t, the suspended undercarriage assembly 200 is connected to the leading and trailing secondary frame members 120l, 120t. As will be described below, the leading and trailing bushing assemblies 240l, 240t enable the suspended undercarriage assembly 200 to pivot about the undercarriage pivot axis 234, and enable the suspended undercarriage assembly 200, and thus the undercarriage pivot axis 234, to move vertically and laterally.

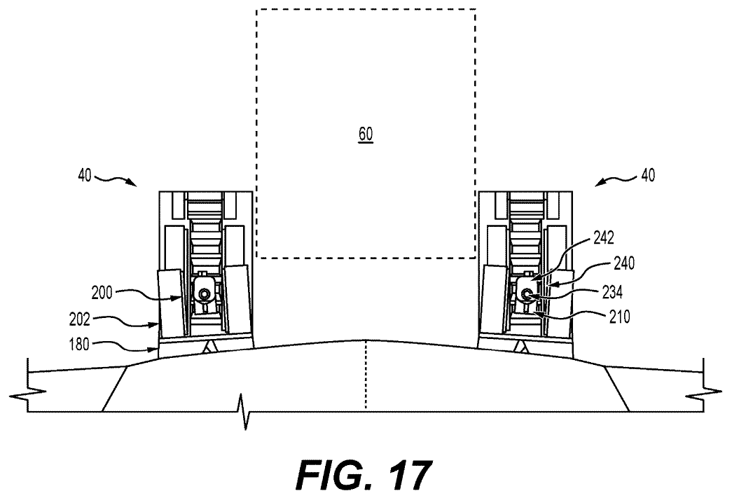

Referring to FIGS. 16A to 16C and 17, the track system 40 in operation will be described.

As shown in FIG. 16A, when the track system 40 is on a flat level surface, the track system 40 is in a rest configuration.

As shown in FIG. 17, when the vehicle 60 travels on a crowned road (i.e., a sloped terrain), the beam 210, and thus the support wheel assemblies 202, pivot about the undercarriage pivot axis 234 to conform to the crowned road. Thus, it can be said that the beam 210 and the support wheel assemblies 202 are capable of roll motion relative to primary and secondary frame members 110, 120l, 120t. This relative movement between the suspended undercarriage assembly 200 and the rest of the frame assembly 100 is in part enabled by the bushing assemblies 240l, 240t. When the beam 210 and the support wheel assemblies 202 pivot about the undercarriage pivot axis 234, to conform to the ground, the leading pin 232l and the trailing pin 232t also pivot about the undercarriage pivot axis 234. The movement of the leading and trailing pins 232l, 232t is enabled by the resiliently deformable nature of the bushings 242. As a result of the movement of the leading and trailing pins 232l, 232t, and because of their fixed connection to the bushings 242, the bushings 242 are resiliently deformed circumferentially about the undercarriage pivot axis 234. In response to the bushings 242 being resiliently deformed, the bushings 242 bias the beam 210 back toward its rest position (FIG. 16A). The bushings 242 are structured to permit movement of the beam 210 relative to the rest of frame assembly 100 in a predetermined range. In some embodiments, a deformation of the bushings 242 may be limited by stoppers. In the present embodiment, the beam 210 and the support wheel assemblies 202 can roll about the undercarriage pivot axis 234 by an angle ranging between about −10 degrees to +10 degrees relative to the multi-member frame assembly 100.

In FIG. 16B, an example of the suspended undercarriage assembly 200 having pivoted about the undercarriage pivot axis 234 in a first direction is shown. In this example, to conform to a ground surface, the support wheel axis 220 has moved by angle α between the rest position and a position 220′, which corresponds to a rotation about the undercarriage pivot axis 234 of 5 degrees in a first direction.

In FIG. 16C, an example of the suspended undercarriage assembly 200 having pivoted about the undercarriage pivot axis 234 in a second direction is shown. In this example, to conform to a ground surface, the support wheel axis 220 is moved by angle α′ between the rest position and a position 220″, which corresponds to a rotation about the undercarriage pivot axis 234 of 5 degrees in a second direction.

Additionally, when the track system 40 travels over an obstacle such as a bump or a hole, the beam 210 and the support wheel assemblies 202 can move vertically with reference to rest of the frame assembly 100 (i.e., vertically away or toward the drive wheel assembly 300). This vertical movement is enabled by the resiliently deformable nature of the bushings 242 (shown in FIGS. 14D to 14F). More specifically, in response to the beam 210 moving vertically, the leading and trailing pins 232l, 232t also move vertically, which causes the bushings 242 to resiliently deform in the vertical direction. In some embodiments, the beam 210 may move laterally. In can be said that the bushings 242 are resiliently deformed radially about the undercarriage pivot axis 234. By deforming in response to the movement of the beam 210, the bushings 242 absorb at least a portion of the impact induced by the obstacle over which the track system 40 travels. The bushings 242 thus provides some damping of the suspended undercarriage assembly 200 relative to the rest of the frame assembly 100, thereby improving ride quality.

The suspended undercarriage assembly 200 thus enables the endless track 180 to better conform to the terrain on which the track system 40 travels, and that at least over the portion of the ground-engaging segment 181 of the track 180 that extends underneath the support wheel assemblies 202.

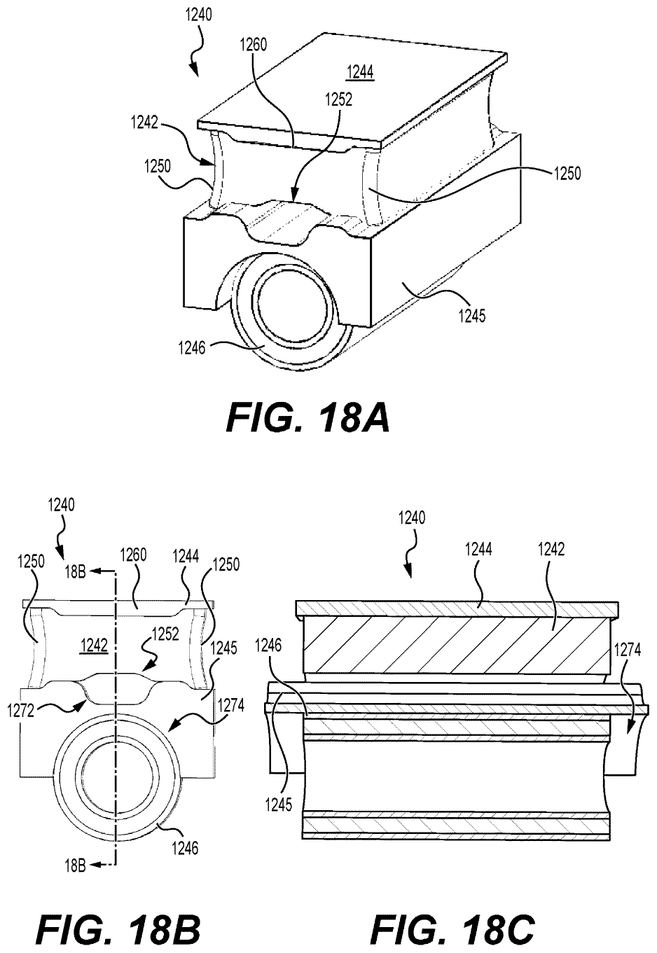

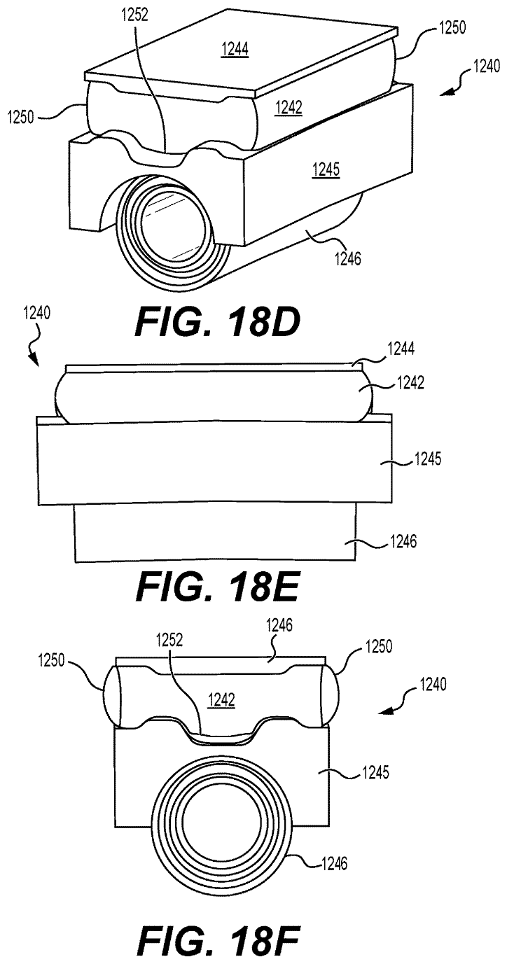

With reference to FIGS. 18A to 18F, a bushing assembly 1240 according to an alternative embodiment of the present technology will be described. It will be appreciated that the bushing assembly 1240 may be configured to be a leading bushing assembly or a trailing bushing assembly. Features of the bushing assembly 1240 similar to the features of the bushing assembly 240 have been labeled with the same reference numerals, and will not be re-described herewith.

The bushing assembly 1240 includes a bushing 1242 (which may be referred to as body), an upper plate 1244, a lower plate 1245, and a sleeve 1246. In some embodiments, the upper and lower plates 1244, 1245 may be considered to form a bushing housing.

The bushing 1242 is shaped to deform in a certain way along a generally predetermined area. Indeed, the bushing 1242 has concave sides 1250, and a recessed section 1252 at a bottom thereof.

The upper plate 1244 has abutting portions 1260 disposed at either longitudinal end thereof. The abutting portions 1260 extend vertically downward and can limit movement of the bushing 1242 relative to the upper plate 1244 in the longitudinal direction. In some embodiments, the bushing 1242 may be connected to the upper plate 1244 by an adhesive. In another embodiment, the bushing 1242 may connected to the upper plate 1244 by an overmolding process. It is contemplated that the bushing 1242 may be connected to the upper plate 1244 differently. It is contemplated that in some embodiments, the upper plate 1244 may be part of the frame assembly 100 (e.g., integrated to one of the leading and trailing secondary members).

The lower plate 1245 defines a recessed section 1272 on a top side thereof. The recessed section 1272 is generally laterally aligned with the recessed section 1252 of the bushing 1242, and is configured to receive part of the bushing 1242 as the bushing 1242 undergoes deformation. At a bottom side thereof, the lower plate 1245 defines an arcuate section 1274 that is configured to receive the sleeve 1246 therein. It is contemplated that in some embodiments, the sleeve 1246 may be integral with the lower plate 1245.

In this embodiment, when the sleeve 1246 rotates due to the rotation of a corresponding one of the leading and trailing pins 232l, 232t, the bushing 1242 is not directly subjected to torsional deformation, as may be the case for the bushing 242. Instead, the sleeve 1246 causes the lower plate 1245 to pivot such that the bushing 1242 is mostly subjected to a compressive load. This can increase life of the bushing 1242, as some polymeric material can generally withstand compressive loads better than they can withstand torsional loads, in some cases.

As shown in FIGS. 18D to 18F, when the bushing 1242 deforms to a compressed state, the recessed section 1252 deforms so as to fill the recessed section 1272, and the concave sides 1250 deform to become convex. Longitudinal ends of the bushing 1242 also deform to become convex, similarly to the concave sides 1250.

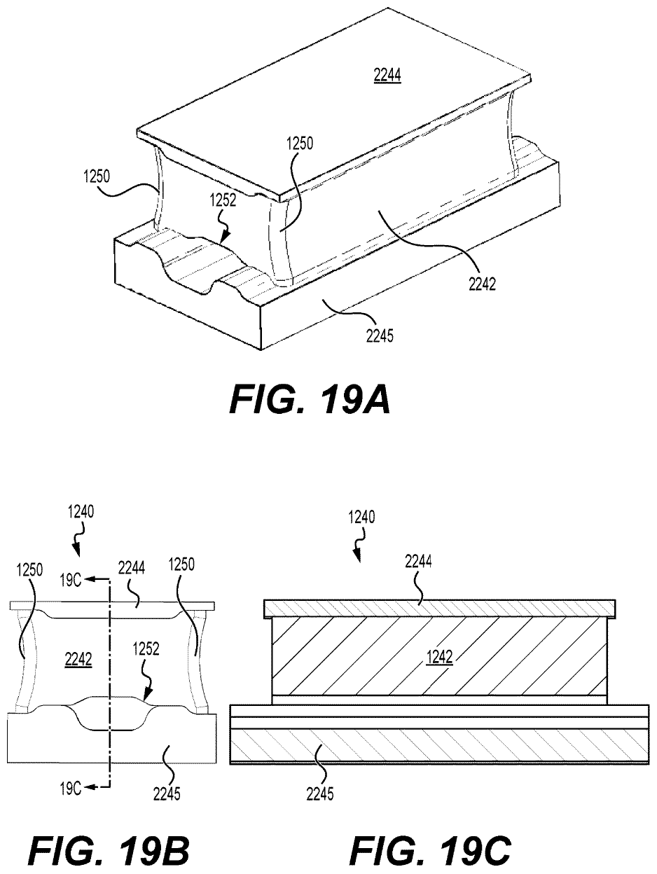

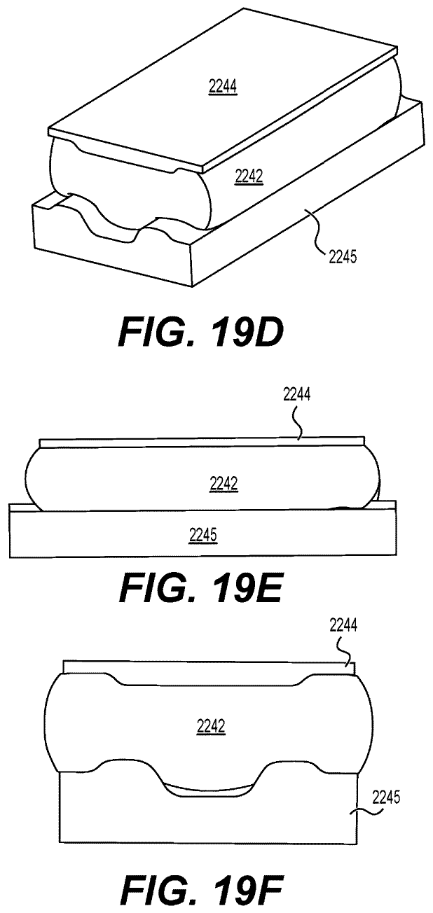

Referring to FIGS. 19A to 19F, a bushing 2242 according to an alternative embodiment of the present technology will be described. It will be appreciated that the bushing 2242 may be configured to be a leading bushing or a trailing bushing. Features of the bushing 2242 similar to the features of the bushing assemblies 240, 1240 have been labeled with the same reference numerals, and will not be re-described herewith.

The bushing 2242 has, like the bushing 1242, concave sides 1250, and a recessed section 1252 at a bottom thereof.

In this embodiment, however, the bushing 2242 is connected to an upper portion 2244 of a corresponding one of the secondary leading and trailing frame member 120l, 120t, and to a lower portion 2245 of the beam 210. In this embodiment, the sleeve 1246 and the pins 232l, 232t have been omitted.

In response to a movement of the beam 310 relative to the secondary leading and trailing frame member 120l, 120t, the lower portion 2245 moves toward the upper portion 2244 causing deformation of the bushing 2242. The bushing 2242 mostly deforms in compression, similarly to the bushing 1242.

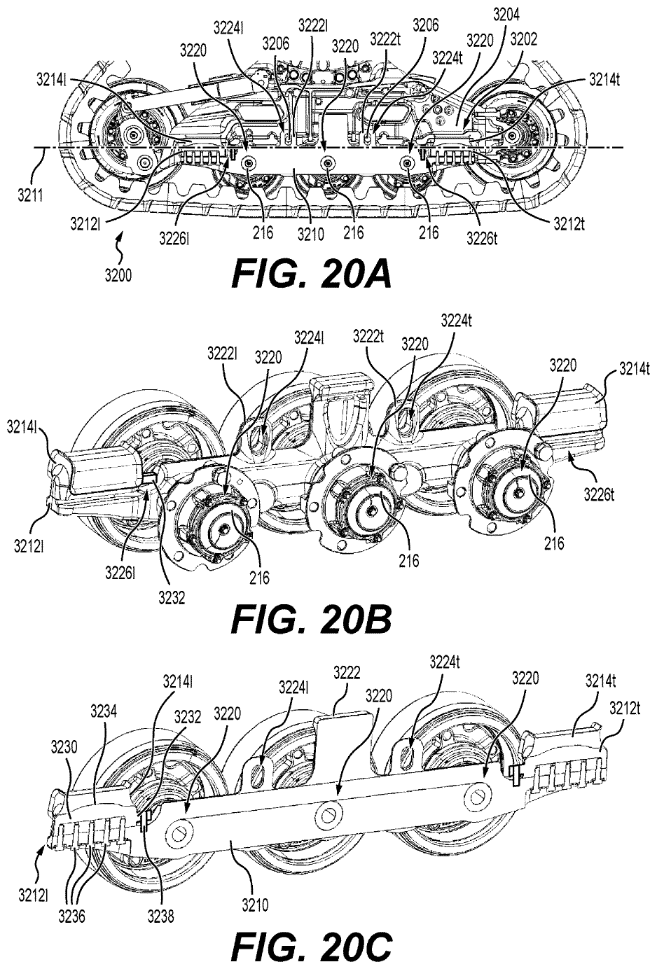

Referring now to FIGS. 20A to 20C, a suspended undercarriage assembly 3200 according to an alternative embodiment of the present technology will be described. Features of the suspended undercarriage assembly 3200 similar to those of the suspended undercarriage assembly 200 have been labeled with the same reference numerals, and will not be re-described in detail herewith.

In the present embodiment, as partially shown in FIG. 20A, the suspended undercarriage assembly 3200 is configured to be received in a cavity 3202 defined in a frame member 3204. In some embodiments, the cavity 3202 may be defined by two or more frame members. In other embodiments, the suspended undercarriage assembly 200 could be received in a recess, or directly connected to the frame member 3204.

The suspended undercarriage assembly 3200 includes a beam 3210, leading and trailing connecting members 3212l, 3212t, and leading and trailing bushings 3214l, 3214t.

The beam 3210 extends generally longitudinally and defines three longitudinally spaced apertures 3220. Each one of three longitudinally spaced apertures extends generally laterally, and is configured to receive a corresponding one of the axle casing 216 therein. The beam 3210 has a leading upper portion 3222l that defines a leading slot 3224l, and a trailing upper portion 3222t that defines a trailing slot 3224t. The leading and trailing slots 3224l, 3224t extend generally vertically. The beam 3210 further defines leading and trailing recesses 3226l, 3226t that are configured to receive part of the leading and trailing connecting members 3212l, 3212t therein. It is contemplated that in some embodiments, the leading and trailing recesses 3226l, 3226t may be omitted, and the leading and trailing connecting members 3212l, 3212t may be connected to leading and trailing portions of the beam 3210 differently.

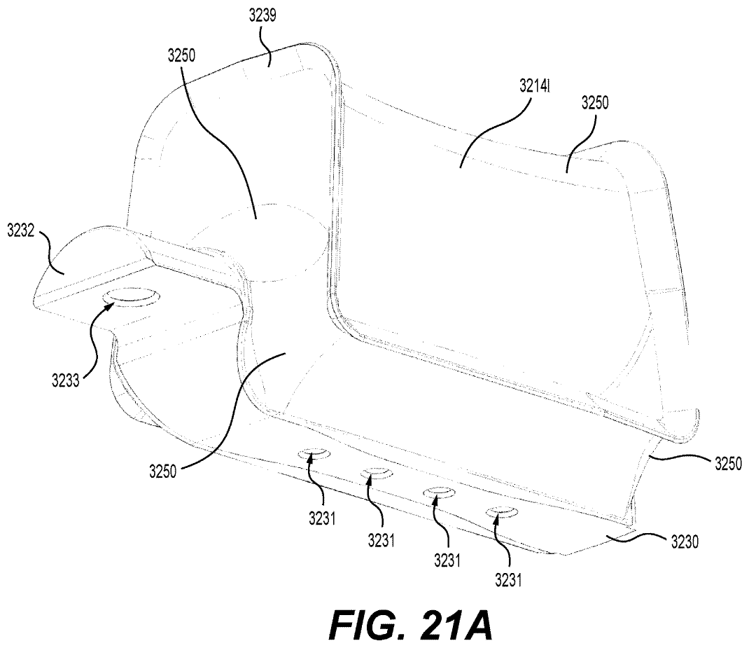

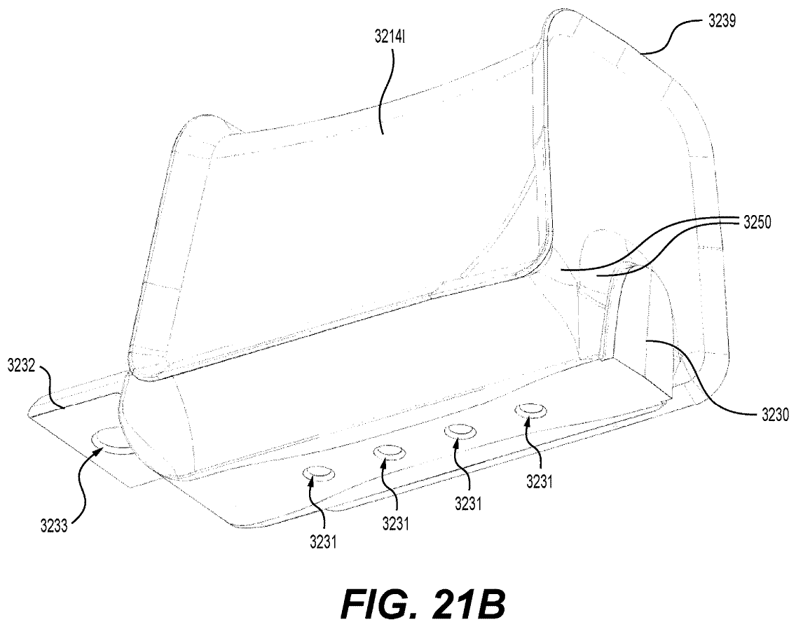

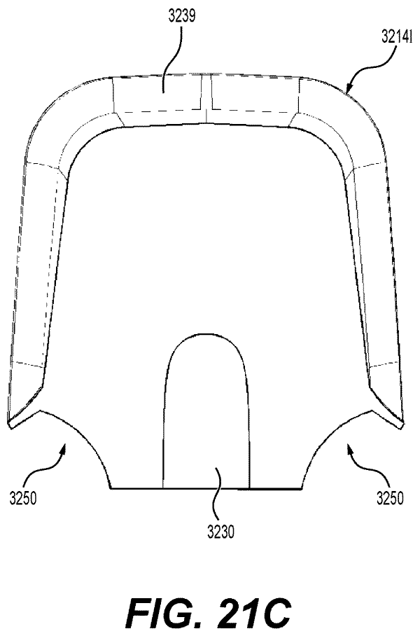

As mentioned above, and as shown in FIG. 21A, the beam 3210 is configured to be received in the cavity 3202. The beam 3210 and the frame member 3204 are, inter alia, connected via leading and trailing pegs 3206 that are received in, respectively, the leading and trailing slots 3224l, 3224t.

Referring to FIGS. 20A to 20C and 21A to 21C, an embodiment of the leading and trailing connecting members 3212l, 3212t will now be described in greater detail. As the leading and trailing connecting members 3212l, 3212t are similar, only the leading connecting member 3212l will be described herewith.

The leading connecting member 3212l has a connecting portion 3230 and a flange portion 3232. Best seen in FIG. 20C, the connecting portion 3230 has, in the longitudinal direction, a curved upper surface 3234. The curved upper surface 3234 has a convex profile, but may be shaped differently in other embodiments). The curved upper surface 3234 can assist in controlling deformation of the bushing 3214l. In some cases, the curved upper surface 3234 may assist in positioning the bushing 3214l, which has a complementary profile, on the leading connecting member 3212l. As best seen in FIG. 21C, a cross-section of the connecting portion 3230 taken along a lateral plane generally resembles an arch shape, with a curved upper section, and a flat lower section, which can assist in controlling deformation depending load.

Additionally, the connecting portion 3230 defines apertures 3231. In the illustrated embodiment, there are four apertures 3231, but it is contemplated that the number of apertures could vary. Each one of the apertures 3231 is configured to receive a bolt 3236 therein. The bolts 3236 fasten the beam 3210 and the leading connecting member 3212l to one another. The flange portion 3232 defines an aperture 3233. The aperture 3233 is configured to receive a dowel pin 3238. The dowel pin 3238 is also received in an aperture defined in the beam 3210. The dowel pin 3238 reinforces the connection between the leading connecting member 3212l and the beam 3210, particularly when shearing forces are applied.

The leading and trailing bushings 3214l, 3214t are similar, thus only the leading bushing 3214l will be described in greater detail. The leading bushing 3214l is made of a resilient material. In some embodiments, the resilient material is a polymeric material like rubber.

The leading bushing 3214l has been configured to control deformation thereof, while maximizing a vertical range of motion provided thereby (i.e., range of motion provided to the beam 3210). As best seen in FIGS. 21A and 21B, the leading bushing 3214l has a plurality of concave sections 3250 to minimize likelihood of pinching within the leading bushing 3214l, which can sometimes result from an excessive compression of the leading bushing 3214l. Some of the concave section 3250 are fillets. The presence of the concave sections 3250 can enhance life of the leading bushing 3214l. In the present embodiment, the leading bushing 3214l is also provided with a lip 3239. The lip 3239 extends outwardly from the leading bushing 3214l and is positioned along edges thereof. In the present embodiment, there is one continuous lip 3239, but it is contemplated that in some embodiments, there could be two or more lips. In some embodiments, thickness of the lip 3239 and/or height thereof (i.e., how much it extends from the edge of the leading bushing 32141) are uniform. As will be described below, in other embodiments, thickness and/or height of the lip 3239 may vary. The lip 3239 can assist, when the frame assembly is fully assembly, in limiting infiltration of debris such as sand, water and mud between the leading bushing 3214l and the surfaces to which the leading bushing 3214l is connected.

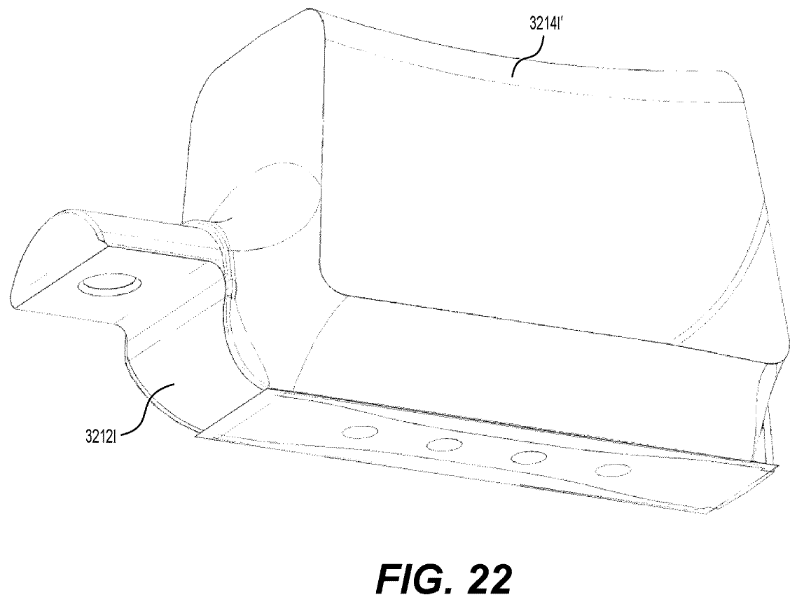

Referring to FIG. 22, a leading bushing 3214l′ according to an alternative embodiment is shown. The leading bushing 3214l′ notably differs from the leading bushing 3214l in that the leading bushing 3214l′ does not have the lip 3239.

Referring back to FIGS. 21A and 21B, in some embodiments, the leading bushing 3214l may be fixedly connected to the leading connecting member 3212l (e.g., via an adhesive or an overmolding process). In other embodiments, the leading bushing 3214l may be interlocked with the leading connecting member 3212l so that the leading bushing 3214l and the leading connecting member 3212l do not move relative to one another. In some embodiments, the interlock may be provided by chemical bonding or by physical engagement. More specifically, as shown in FIG. 20C, the leading bushing 3214l and the leading connecting member 3212l are partially complementary to one another (i.e., shape of the leading bushing 3214l is complementary to the shape of the leading connecting member 3212l), which can assist, in some cases, in preventing relative movement therebetween.

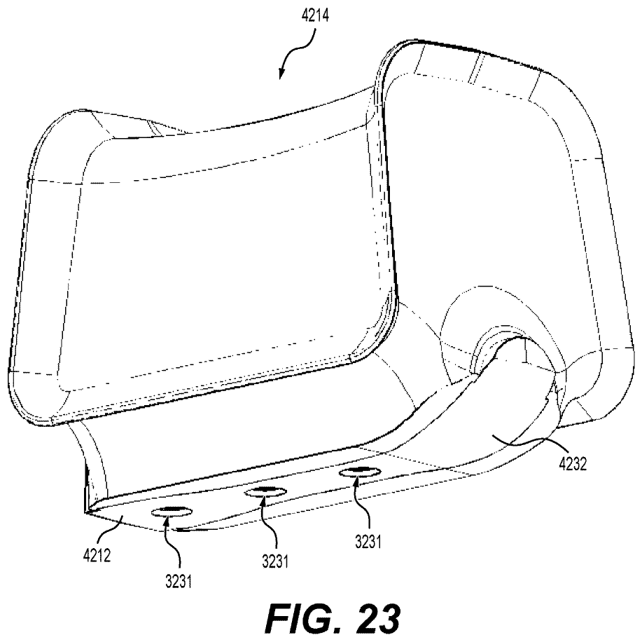

Referring to FIG. 23, a connecting member 4212 and a bushing 4214 according to alternative embodiments of the present technology will be described. Features of the connecting member 4212 and the bushing 4214 similar to, respectively, the connecting member 3212 and the bushing 3214 have been labeled with the same reference numerals and will not be re-described in detail herewith.

The connecting member 4212 notably differs from the connecting member 3212 in that the connecting member 4212 does not have a flange portion 3232. Instead, the connecting member 4212 has a sloped portion 4232 that is complementary to a sloped region of the beam 3210 (seen in FIG. 20C). The connecting member 4214 defines three apertures 3231. In some embodiments, the connecting member 4212 could further define an aperture configured to receive a dowel pin therein.

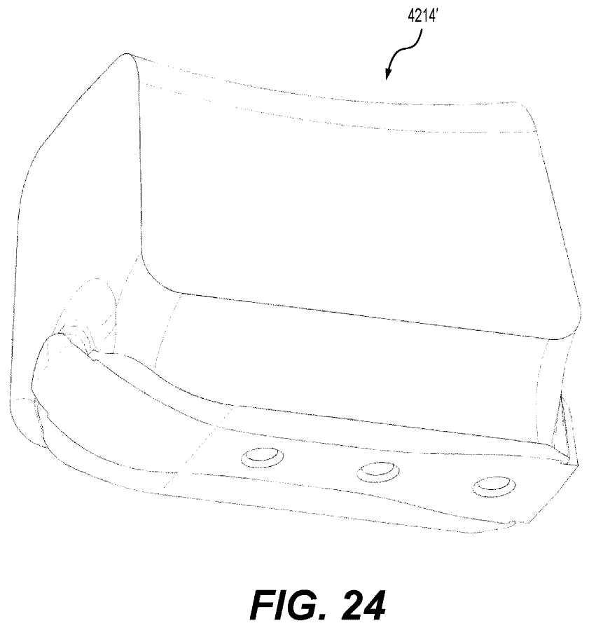

The bushing 4214 is generally similar to the bushing 3214. It is contemplated that in some embodiments, as shown in FIG. 24, a bushing 4214′ may not be provided with the lip 3239.

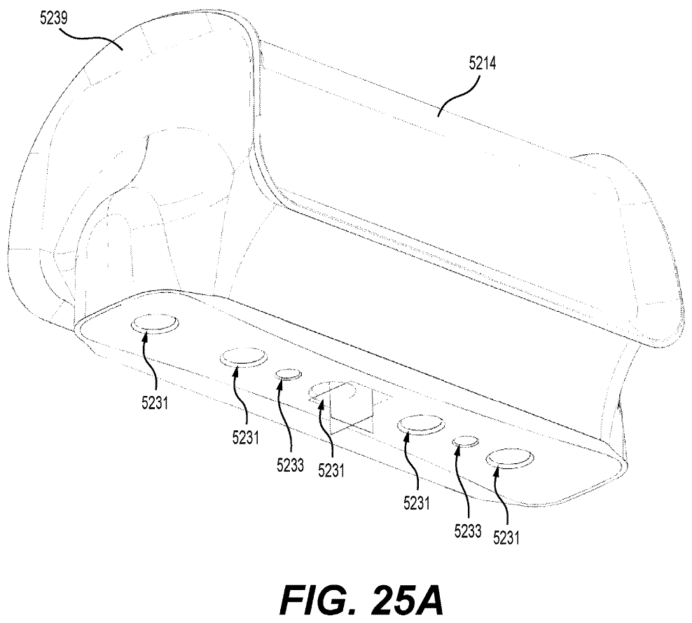

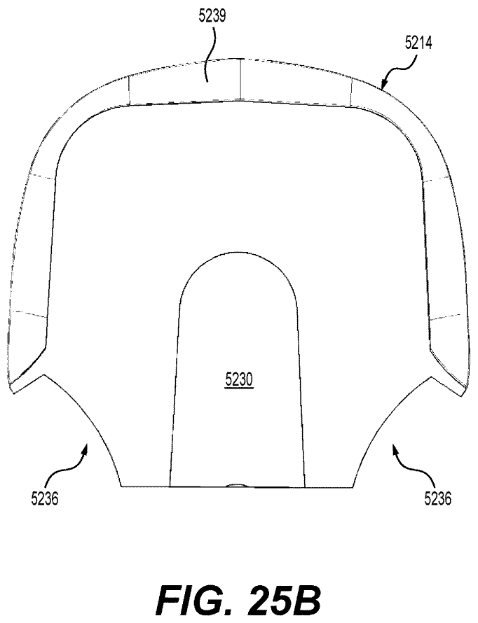

Referring to FIGS. 25A and 25B, a connecting member 5212 and a bushing 5214 according to alternative embodiments of the present technology will be described. Features of the connecting member 5212 and the bushing 5214 similar to, respectively, the connecting member 3212 and the bushing 3214 have been labeled with the same reference numerals and will not be re-described in detail herewith.

In this embodiment, the connecting member 5212 notably differs from the connecting member 3212 in that the connecting member 5212 does not have the flange portion 3232. The connecting member 5212 has a connecting portion 5230 that is generally prismatic, with a flat lower surface.

A cross-section of the connecting portion 5230, shown in FIG. 25B, taken along a lateral plane generally resembles an arch shape, with a curved upper section, and a flat lower section. The cross-section of the connecting portion 5230 may vary from one embodiment to another. The connecting member 5212 defines vertically extending apertures 5231 that are configured to receive fasteners (not shown) for fastening the connecting member 5212 to the beam 3210, and vertically extending apertures 5233 configured to receive dowel pins (not shown) for reinforcing connection between the connecting member 5212 and the beam 3210.

In this embodiment, the bushing 5214 is connected to the connecting member 4214 via overmolding. It is contemplated that the bushing 5214 and the connecting member 5212 may be connected differently. As best seen in FIG. 25B, the bushing 5214 has lower side sections 5236. The lower side sections 5236 are generally concave. The lower side sections 5236 being concave can assist the resilient material in adhering to the connecting member 5212, while also increasing amount of resilient material at a central portion of the connecting member 5212, and decreasing amount of resilient material that is required to manufacture the bushing 5214. The lower side sections 5236 can further assist in controlling the deformation of the bushing. In this embodiment, the bushing 5214 also has a lip 5239 that extends outwardly from edges of the bushing 5214. In this embodiment have been optimized to better react during deformation of the bushing 5214. More specifically, an amount of material present at the corner has been reduced, and curvature radii of the corners of the lip 5239 has been increased Thus, thickness of the lip 5239 and height thereof (i.e., how much it extends from the edge of the leading bushing 3214l) varies along the edges of the bushing 5214.

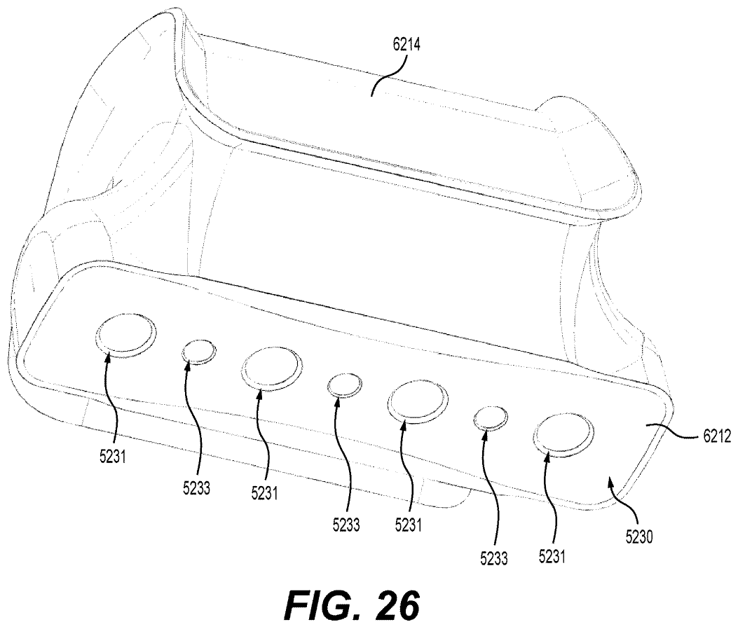

Referring to FIG. 26, a connecting member 6212 and a bushing 6214 according to alternative embodiments of the present technology are shown. The connecting member 6212 is generally similar to the connecting member 5212, and the bushing 6214 is generally similar to the bushing 5214.

The bushing 6214 notably differs from the bushing 5214, in that the bushing 6214 is made of less resilient material in volume. Indeed, while a length of the connecting member 6212 is generally similar to a length of the connecting member 5212, part of bushing 6214 has been shortened in the longitudinal direction. This reduction in manufacturing material required to make the bushing 6214 can result in reducing manufacturing costs, without negatively impacting range of motion provided thereby to the beam 3210.

Referring back to FIGS. 20A to 20C, the suspended undercarriage assembly 3200 in operation will be described. When the suspended undercarriage assembly 3200 is connected to the frame member 3204, the leading and trailing bushings 3214l, 3214t are resiliently deformed. Thus, as schematically shown in FIGS. 20A to 20C, in a resting configuration of the track system to which the suspended undercarriage assembly 3200 is connected, the leading and trailing bushings 3214l, 3214t are pre-loaded (i.e., the leading and trailing bushings 3214l, 3214t are pre-clamped).

When the track system is travelling on a uneven terrain, the beam 3210 can move relative to the frame member 3204. The relative movement between the beam 3210 and the frame member 3204 is in part enabled by the leading and trailing bushings 3214l, 3214t.

In response to the beam 3210 moving vertically, or pivoting about an axis. 3211, the leading and trailing bushings 3214l, 3212t are subjected to compressive loads, and the leading and trailing bushings 3214l, 3212t bias the beam 3210 back toward the rest configuration. The shape of the leading and trailing bushings 3214l, 3214t, partly due to their shape (e.g., concave profiles) can assist in guiding the deformation. Sometimes, the deformation is guided generally vertically.

As the beam 3210 moves, the leading and trailing pegs 3206 move within, respectively, the leading and trailing slots 3224l, 3224t. The leading and trailing pegs 3206 and the leading and trailing slots 3224l, 3224t are configured to act as stoppers to limit movement of the beam 3210 relative to the frame member 3202.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A suspended undercarriage assembly connectable to a frame assembly of a track system, the undercarriage assembly comprising:
a beam having a leading portion and a trailing portion;
at least one support wheel assembly connected to the beam;
a leading pin connected to the leading portion of the beam;
a trailing pin connected to the trailing portion of the beam;
a leading bushing assembly having a leading body fixedly connected to the leading pin, the leading body being made of a resilient material, and the leading bushing assembly being configured to connect to the frame assembly;
a trailing bushing assembly having a trailing body fixedly connected to the trailing pin, the trailing body being made of a resilient material, and the trailing bushing assembly being configured to connect to the frame assembly;
the leading and trailing bodies are configured to promote deformation in at least one direction, and
with the suspended undercarriage assembly being connected to the frame assembly via the leading and trailing bushing assemblies, the leading and trailing bodies enable the beam to move in the at least one direction relative to the frame assembly, and in response to the beam moving, the leading and trailing bodies bias the beam toward an initial position.

2. The suspended undercarriage assembly of claim 1, wherein the leading and trailing pins are integral with the beam.

3. The suspended undercarriage assembly of claim 1, further comprising:
a leading plate connected to the leading portion of the beam, the leading pin being connected to the leading plate; and
a trailing plate connected to the trailing portion of the beam, the trailing pin being connected to the trailing plate.

4. The suspended undercarriage assembly of claim 1, wherein the leading bushing assembly is configured to be received in a leading recess of a member of the frame assembly, and the trailing bushing assembly is configured to be received in a trailing recess of a member of the frame assembly.

5. The suspended undercarriage assembly of claim 1, wherein the leading bushing assembly includes a leading housing, the leading body being received in the leading housing, and the trailing bushing assembly includes a trailing housing, the trailing body being received in the trailing housing.

6. The suspended undercarriage assembly of claim 1, wherein the leading bushing assembly includes a leading sleeve receiving at least part of the leading pin therein, and the trailing bushing assembly includes a trailing sleeve receiving at least part of the trailing pin therein.

7. The suspended undercarriage assembly of claim 6, wherein the leading body defines an aperture configured to receive the leading sleeve therein, the leading sleeve being fixedly connected to the leading body, and the trailing body defines an aperture configured to receive the trailing sleeve therein, the trailing sleeve being fixedly connected to the trailing body.

8. The suspended undercarriage assembly of claim 1, wherein at least one of the leading and trailing bodies has a concave profile for promoting deformation in the at least one direction.

9. The suspended undercarriage assembly of claim 8, wherein the concave profile is at a longitudinal forward end or longitudinal rearward end of the at least one of the leading and trailing bodies.

10. The suspended undercarriage assembly of claim 1, wherein the at least one direction is at least one of a vertical direction and a lateral direction.

11. The suspended undercarriage assembly of claim 1, wherein the leading pin is connected to the leading body closer to a bottom surface of the leading body than to a top surface of the leading body; and the trailing pin is connected to the trailing body closer to a bottom surface of the trailing body than to a top surface of the trailing body.

12. The suspended undercarriage assembly of claim 11, wherein a majority of resilient material of the leading body is disposed vertically higher than the leading pin, and a majority of resilient material of the trailing body is disposed vertically higher than the trailing pin

13. The suspended undercarriage assembly of claim 12, wherein the at least one support wheel assembly includes three longitudinally spaced support wheel assemblies.

14. The suspended undercarriage assembly of claim 1, wherein in response to the beam pivoting about a longitudinal axis defined by the leading and trailing pins, at least one of the leading and trailing bodies undergoes a torsional deformation.

15. A frame assembly for a track system, the frame assembly comprising:
a main body; and
the suspended undercarriage assembly of claim 1 connected to the main body.

16. A track system comprising:
the frame assembly of claim 15,
a leading idler wheel assembly connected to the frame assembly;
a trailing idler wheel assembly connected to the frame assembly;
a sprocket wheel assembly rotationally connected to the frame assembly; and
an endless track surrounding the frame assembly, the leading and trailing idler wheel assemblies, and the sprocket wheel assembly.

17. A frame assembly for a track system, the frame assembly comprising:
a frame member;
a suspended undercarriage assembly moveably connected to the frame member, the suspended undercarriage assembly comprising:
a beam having a leading portion and a trailing portion;
a leading bushing connected to the leading portion of the beam;
a trailing bushing connected to the trailing portion of the beam;
the leading and trailing bushings being made of a resilient material, and configured to promote deformation in at least one direction, and
in response to the beam moving relative to the frame member, the leading and trailing bushings bias the beam toward an initial position.

18. The frame assembly of claim 17, wherein the frame member defines a cavity, and the suspended undercarriage assembly is at least partially received in the cavity.

19. The frame assembly of claim 17, wherein:
the frame member has a frame limiter;
the beam has a beam limiter operationally connected with the frame limiter; and
the frame limiter and the beam limiter are configured to limit movement of beam relative to the frame member.

20. The frame assembly of claim 19, wherein one of the frame limiter and the beam limiter is a slot, and an other one of the frame limiter and the beam limiter is a peg received in the slot.

21.-31. (canceled)
